(19) United States
(12) Patent Application Publication
(10) Pub. No.: US 2025/0203352 A1
(43) Pub. Date: Jun. 19, 2025

(54) GPS(and/or other data positioning information) and other personal information data integrated in data and voice communication

(71) Applicant: MFB Enterprises, Tenafly, NJ (US)

(72) Inventor: Max Basch, Tenafly, NJ (US)

(21) Appl. No.: 18/652,596

(22) Filed: May 1, 2024

Related U.S. Application Data
(63) Continuation of application No. 63/629,993, filed on Dec. 19, 2023.

(51) Int. Cl. H04W 12/02; G01C 21/00

(52) U.S. Cl. CPC H04W 12/02; G01C 21/005; G01C 21/3848

(57) ABSTRACT

The invention described herein provides a novel approach to integrating GPS and/or other data positioning information and other information data into voice or electronic communications, enabling enhanced functionalities for location-based services and personal information, while allowing users and system control over the inclusion or exclusion of such data. This technology opens new possibilities for location-aware and specific data communication across various mediums.

### CROSS-REFERENCE TO RELATED APPLICATIONS

Continuation of application No. 63/629,993 filed on December 24, 2023.

### BACKGROUND OF THE INVENTION

Traditional voice and electronic communications, such as phone calls, text messages, and emails, lack real-time location awareness or personal information of the sender or receiver. This limitation hinders a variety of potential applications, particularly in emergency situations, navigation, and location-based services, advertising and commercial applications.

### SUMMARY OF THE INVENTION

The present invention addresses the aforementioned limitation by integrating Global Positioning Systems—GPS (and/or other data positioning information) and other personal information data into the information transmitted and received in voice, data and electronic communications. The present invention relates to the integration of GPS (and/or other data positioning information) and other personal information data within voice or any electronic communications, in both the sender and/or the receiver enabling the transmission, reception, and utilization of location information or other data information in various forms of communication mediums, including but not limited to phone calls, text messages, emails, or any electronic communication.

The present invention pertains to a system and method for incorporating GPS (and/or other data positioning information) and other personal information data into voice or electronic communications. The integration occurs during the initiation of communication by the sending party, and automatically upon receiving of the communication by the receiving party, wherein the GPS (and/or other data positioning information) and other personal information data of the sender is transmitted alongside the communication data and the receiving party upon receipt of any electronic communication sent out its own GPS (and/or other data positioning information) and other personal information data.

In case that only one party is enabled by this invention the enabled party will have this functionality indifferent if the other part has it or not.

When both parties are enabled by this invention the exchange of data is automatic and controlled by the user's settings or by the network overrides.

This integration facilitates the ability of the receiving and sending party to locate the sender and receiver and access functionalities related to GPS (and/or other data positioning information) and other personal information data, such as, but not limited to, address retrieval, navigation to specific points, distance calculation, time estimation, person's image, and more. The invention also allows for the inclusion or removal of GPS (and/or other data positioning information) and other personal information data at the sender or receiver's discretion, with potential of user or system-based overrides based on carrier or other external factors.

If one of the communicating parties changes location during the electronic exchange of information, the positioning information sent and received (GPS and/or other data positioning information) changes to update the new position location, allowing for a dynamic mapping of the position changes in real or near real time.

This invention offers such unique functionalities, and other not described here, but related to the presence of the GPS (and/or other data positioning information) and other personal information data:

Automatic GPS (and/or other data positioning information) and other personal information data Location Sharing: Upon initiating a voice call, text message, email, or any other electronic communication, the sender's and receiver GPS (and/or other data positioning information) and other personal information data is automatically embedded and transmitted within the content of the message.

Location-Based Information Generation: Both the sender and the recipient's device parses the embedded GPS (and/or other data positioning information) and other personal information data and instantly generates various location-related functionalities, such as:

Displaying the sender's and receiver's address on a map (sender's information on the receiver's unit and receiver's information on the sender's unit).

Providing turn-by-turn navigation directions to the sender's or receiver's location.

Estimating the distance and travel time between the sender and recipient.

Responsive GPS (and/or other data positioning information) and other personal information data Integration: When the recipient accesses or responds to the communication, their GPS (and/or other data positioning information) and other personal information data is similarly embedded in their response, offering location and data awareness for both parties.

Automatic personal information displayed when the voice or data communication is received and/or the receiver accepts the call (picture, medical information, etc.).

Example are but not limited to: name and location of a business, picture of a child or parent, commercial offerings or promotions, emergency messages, etc.

User-Controlled Opt-In/Opt-Out: Both sender and recipient can choose to include or exclude their GPS (and/or other data positioning information) and other personal information data in the communication through user-interface controls.

System Overrides: To ensure safety and security, the system can override user preferences in specific situations, such as emergency calls or carrier-mandated location sharing policies.

The GPS (and/or other data positioning information) and other personal information data can be generated by the network or by the communicating devices if the network did not generate such information.

### DETAILED DESCRIPTION OF THE INVENTION

GPS (and/or other data positioning information) and other personal information data Module: Integrates with the sender's and recipient's communication device to determine their current location and personal information (Image, data, etc.).

Data Embedding/Extraction Engine: Analyzes and modifies the communication content to seamlessly embed and extract GPS (and/or other data positioning information) and other personal information data in a secure and standardized format.

Location and data Information Processing: Parses the embedded GPS (and/or other data positioning information) and other personal information data and generates related information, such as addresses, maps, navigation routes, images or data etc.

Automatic location of a device (receiver or sender) without the necessity of sending any distress or other messages.

Integration of generating and decoding of the GPS (and/or other data positioning information) and other personal information data in communicating devices.

Integration of generating and decoding of the GPS (and/or other data positioning information) and other personal information data by networks generating the messages.

Producing the electronic message or added by the sending or receiving device if such data is not generated by the network.

User Interface: Allows users to control their opt-in/opt-out preferences for automatic location sharing.

Allow systems and carriers to determine the use of such information, overrides and options.

### Advantages of the Invention

The invention offers numerous advantages over existing communication methods, including others not mentioned below:

Enhanced Emergency Response: Emergency responders can quickly locate individuals in distress by automatically accessing their GPS (AND/OR OTHER DATA POSITIONING INFORMATION) AND OTHER PERSONAL INFORMATION DATA coordinates through calls or messages.

Improved Navigation: Recipients can easily navigate to the sender's location, facilitating meetings and deliveries.

Increased Personal Safety: Sharing location information in specific situations can deter criminal activity and provide peace of mind.

Enhanced Personalization: Location-based services and personal information can be tailored to the user's context, offering more relevant information and functionality.

### Development of New Safety Systems

### Easy Advertising of Services

Identifying the business, person or other information upon receiving or sending a message.

I claim:

1. A method for integrating GPS (and/or other data positioning information) and other personal information data into voice and electronic communications, comprising the steps of:
Determining the GPS (and/or other data positioning information) and other personal information data of a sender initiating a communication;
Embedding the sender's GPS (and/or other data positioning information) and other personal information data within the communication content;
Transmitting the communication and other personal data with the embedded location data to a recipient;
Parsing the embedded GPS (and/or other data positioning information) and other personal information data on the recipient's device;
Generating location-related information and personal information based on the parsed data in receiver's device;
Generate a dynamic map if the position of one of the communicating devices changes during the data exchange;
Generating Personal data of the sender, not limited to the following examples:
1. Image of the person sending or receiving the communication;
2. Medical data for such communicating parties;
3. Other personal information.

2. The method of claim 1, further comprising the step of receiving response from the recipient, wherein the recipient's GPS (and/or other data positioning information) and other personal information data is embedded within the response comprising the steps of:
Transmitting the communication and other personal data with the embedded location and personal data to a sender from the receiver;
Parsing the receiver's embedded GPS (and/or other data positioning information) and other personal information data on the sender's device;
Generating location-related information and personal information based on the parsed data on sender's device;
Generating Personal data of the receiver, not limited to the following examples:
1. Image of the person sending or receiving the communication;
2. Medical data for such communicating parties;
3. Other persona information;
4. Advertising and Commercial Business.

3. The method of claim 1, further comprising the step of allowing the sender and recipient to opt-in or opt-out of automatic location sharing.

4. The method of claim 1, further comprising the step of overriding user preferences for location sharing or data interpretation in specific situations.

5. A system for implementing the method of claim 1, comprising a GPS (and/or other data positioning information) and other personal information data module for determining the location of the sender and recipient.

6. The method of claim 1, further comprising a data embedding/extraction engine for processing the communication content.

7. The method of claim 1, further comprising a location information processing module for generating location-related information.

8. The method of claim 1, further comprising a user interface for managing location sharing or data interpretation preferences.
